(19) United States
(12) Patent Application Publication
(10) Pub. No.: US 2025/0259235 A1
(43) Pub. Date: Aug. 14, 2025

(54) SYSTEMS AND METHODS FOR PREDICTING RECOMMENDATIONS USING GRAPH RELATIONSHIPS

(71) Applicant: JPMORGAN CHASE BANK, N.A., New York, NY (US)

(72) Inventors: Yawwani GUNAWARDANA, Eastleigh (GB); Zhencheng TAN, Eastleigh (GB); Denis KOCHEDYKOV, Brooklyn, NY (US); Daniel SCHIEMERT, Bad Neuhaim (DE); Ewan MACKIE, London (GB); Leo SCHAABNER, London (GB); Kendeas THEOFANOUS, London (GB)

(21) Appl. No.: 18/441,718

(22) Filed: Feb. 14, 2024

(51) Int. Cl. G06Q 40/04; G06Q 40/06

(52) U.S. Cl. CPC G06Q 40/04; G06Q 40/06

(57) ABSTRACT

Systems and methods for predicting recommendations using graph relationships are disclosed. According to an embodiment, a method may include: (1) monitoring, by a computer program, a messaging interface for transactions; (2) updating, by the computer program, a heterogeneous graph with data from the transactions, wherein the heterogeneous graph identifies a plurality of assets and a plurality of clients; (3) training, by the computer program, a graph model with the heterogeneous graph; (4) querying, by the computer program, the graph model with one of the plurality of assets, wherein the graph model returns a recommendation that identifies a subset of the plurality of clients for the asset; and (5) outputting, by the computer program, the recommendation.

### BACKGROUND OF THE INVENTION

### 1. Field of the Invention

Embodiments generally relate to systems and methods for predicting recommendations using graph relationships.

### 2. Description of the Related Art

Providing certain assets based on clients' requests and recommending possible assets to potential clients are keys for generating successful trades actively. The processes of providing alternative assets to clients when requests cannot be fulfilled and distributing recommended assets among clients are manual and time consuming. Sales typically filter the assets based on criteria like maturity, rating, sector and currency to identify alternative assets. In terms of distributing recommended assets, sales create various lists with clients to send recommendations based on daily axed assets (i.e., trader promoted assets based on previous buys and sells).

### SUMMARY OF THE INVENTION

Systems and methods for predicting recommendations using graph relationships are disclosed. According to an embodiment, a method may include: (1) monitoring, by a computer program, a messaging interface for transactions; (2) updating, by the computer program, a heterogeneous graph with data from the transactions, wherein the heterogeneous graph identifies a plurality of assets and a plurality of clients; (3) training, by the computer program, a graph model with the heterogeneous graph; (4) querying, by the computer program, the graph model with one of the plurality of assets, wherein the graph model returns a recommendation that identifies a subset of the plurality of clients for the asset; and (5) outputting, by the computer program, the recommendation.

In one embodiment, the messaging interface may include a chat interface, and the method may also include extracting, by the computer program, the data from chat in the chat interface using a named entity recognition model.

In one embodiment, each transaction identifies a type of transaction, a client identifier, an asset, and a currency for the asset.

In one embodiment, each transaction further identifies a parent company for the asset, a sector for the asset, a country for the asset, a rating for the asset, and/or a maturity for the asset.

In one embodiment, the step of updating a graph with data from the transactions may include: mapping, by the computer program, asset features to asset nodes in the heterogeneous graph; removing, by the computer program, nodes for the asset features from the graph; mapping, by the computer program, neighbor nodes that are connected to client nodes to the client node; and removing, by the computer program, edges between the neighbor nodes and the client node.

In one embodiment, the method may also include ranking, by the computer program, the subset of the plurality of clients based on a probability of how likely each of the clients is to trade the asset.

In one embodiment, the probability may be further based on a trading history of each client.

According to another embodiment, a system may include: a messaging interface; and an electronic device comprising a computer processor and executing a computer program, wherein the computer program may be configured to monitor the messaging interface for transactions, to update a heterogeneous graph with data from the transactions, wherein the heterogeneous graph identifies a plurality of assets and a plurality of clients, to train a graph model with the heterogeneous graph, to query the graph model with one of the plurality of assets, wherein the graph model returns a recommendation that identifies a subset of the plurality of clients for the asset, and to output the recommendation.

In one embodiment, the messaging interface may also include a chat interface, and the computer program may be further configured to extract the data from chat in the chat interface using a named entity recognition model.

In one embodiment, each transaction identifies a type of transaction, a client identifier, an asset, and a currency for the asset.

In one embodiment, each transaction further identifies a parent company for the asset, a sector for the asset, a country for the asset, a rating for the asset, and/or a maturity for the asset.

In one embodiment, the computer program may be configured to update the graph with data from the transactions by mapping asset features to asset nodes in the heterogeneous graph, by removing nodes for the asset features from the graph, by mapping neighbor nodes that are connected to client nodes to the client node, and by removing edges between the neighbor nodes and the client node.

In one embodiment, the computer program may be further configured to rank the subset of the plurality of clients based on a probability of how likely each of the clients is to trade the asset.

In one embodiment, the probability may be further based on a trading history of each client.

According to another embodiment, a non-transitory computer readable storage medium may include instructions stored thereon, which when read and executed by one or more computer processors, cause the one or more computer processors to perform steps comprising: monitoring a messaging interface for transactions; updating a heterogeneous graph with data from the transactions, wherein the heterogeneous graph identifies a plurality of assets and a plurality of clients; training a graph model with the heterogeneous graph; querying the graph model with one of the plurality of assets, wherein the graph model returns a recommendation that identifies a subset of the plurality of clients for the asset; and outputting the recommendation.

In one embodiment, the non-transitory computer readable storage medium may also include instructions stored thereon, which when read and executed by one or more computer processors, cause the one or more computer processors to perform steps comprising: extracting the data from chat in the messaging interface using a named entity recognition model.

In one embodiment, each transaction identifies a type of transaction, a client identifier, an asset, and a currency for the asset.

In one embodiment, each transaction further identifies a parent company for the asset, a sector for the asset, a country for the asset, a rating for the asset, and/or a maturity for the asset.

In one embodiment, the graph may be updated with data from the transactions by: mapping asset features to asset nodes in the heterogeneous graph; removing nodes for the asset features from the graph; mapping neighbor nodes that are connected to client nodes to the client node; and removing edges between the neighbor nodes and the client node.

In one embodiment, the non-transitory computer readable storage medium may also include instructions stored thereon, which when read and executed by one or more computer processors, cause the one or more computer processors to perform steps comprising: ranking the subset of the plurality of clients based on a probability of how likely each of the clients is to trade the asset, wherein the probability may be further based on a trading history of each client.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for predicting recommendations using graph relationships according to an embodiment;

FIG. 2 illustrates a method for predicting recommendations using graph relationships according to an embodiment;

FIG. 3 depicts an exemplary computing system for implementing aspects of the present disclosure.

### DETAILED DESCRIPTION OF PREFERRED EMBODIMENTS

Embodiments are directed to systems and methods for predicting recommendations using graph relationships.

Embodiments may use information, such as transaction instructions, received from an entity over a chat interface using a knowledge graph. The knowledge graph may model the chat with entities related to trades, and graph neural network models may be used to predict the asset-asset and asset-client recommendations.

For example, embodiments may prepare a graph schema and load nodes/edges into a graph. The heterogeneous graph may include a range of node types, including assets, trades, requests for quotes (RFQs), clients, sales, companies, chat messages, etc. Each node type may include enriched node features that may be used for machine learning modeling. The asset-asset and asset-client recommendation machine learning models may be trained using data from the graph, including, for example, maturity data, country data, currency data, etc., and the source data may be queried using application programming interfaces (APIs).

In one embodiment, client data, including a client name, may be mapped to a unique client identifier in a client hierarchy and trading activities between clients and assets may be used to provide topology information during model training.

For example, a graph may have nodes connected with each other using different edge types. A topology means how these nodes are interconnected with each other to make relationships. These relationships help to find common neighbors and to make better predictions. For example, if two nodes (A and B) have common neighbors then nodes A and B are more connected than nodes A and C.

In one embodiment, natural language processing (NLP) and graph machine learning techniques may be applied to train the models. For example, sentence BERT may be used to generate the asset node feature embeddings and different graph machine learning techniques, including for example Graph Neural Networks, Graph Attention Networks, inductive node embedding frameworks (e.g., GraphSAGE), Temporal Graph Network, etc., may be applied for asset-asset and asset-client recommendations.

The asset-asset recommendation may be a node embedding task and may perform ad hoc asset similarity search using such as maturity, rating, sector, risk country, currency, etc. Here we employ node features to detect similar assets.

Each asset property (e.g., maturity, country, currency, sector, rating, etc.) may be used as the metapath (i.e., a relationship between two nodes using graph relationships) to link different assets and create multiple homogeneous sub-graphs. Each sub-graph may be trained separately to generate the asset node embeddings under a specific metapath. The embeddings from the different metapaths may be combined in a weighted aggregation to create a final asset node embedding. The aggregation allows the final embedding to capture the semantic meaning from each path with weights defined by user to provide the desired results from the similarity search.

The bipartite heterogeneous sub-graph may be created between client and asset nodes with projected trading activity as the edge. From the graph schema, clients may be represented as client nodes. Each client node may be associated with a unique identifier that may be used to identify a client. Relationships for the one-hop neighbors of each asset (e.g., sector, country, maturity, rating, currency, etc.) may be created by merging nodes together onto an asset node and used as asset node features. The client's parent company node may also be projected to client node so the company's name and related level within a client hierarchy may be used as client node feature.

By training the model using an inductive node embedding framework, the probability of an edge between each asset-client pair may be generated and the recommended clients for each asset may be ranked with these probabilities. For each asset, the corresponding recommended clients may be generated, and distribution lists may be created based on the results.

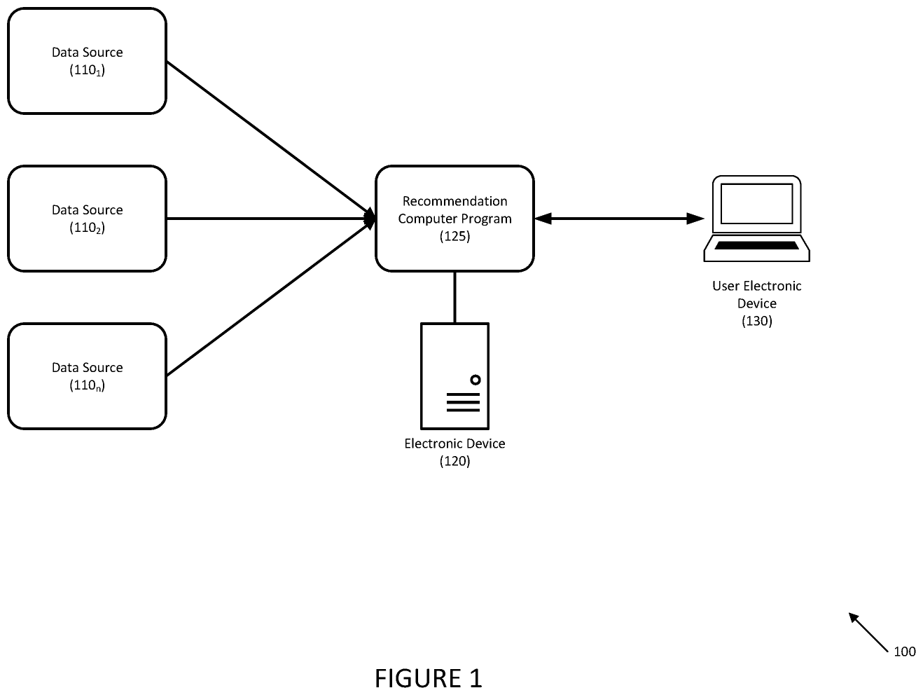

Referring to FIG. 1, a system for predicting recommendations using graph relationships is disclosed according to an embodiment. System 100 may include a plurality of data sources (e.g., messaging systems, transaction systems, Bloomberg messages, trading data, chat data, etc.). Electronic device 120, which may be a server (e.g., physical and/or cloud-based), computer (e.g., workstation, desktop, laptop, notebook, tablet, etc.), smart device, Internet of Things (IoT) appliance, etc. may execute recommendation computer program 125.

Recommendation computer program 125 may receive data from data sources 110 (e.g., data source 110₁, data source 110₂, . . . data source 110ₙ) and may generate a graph. From the graph, recommendation computer program may provide recommendations to, for example, user electronic device 130.

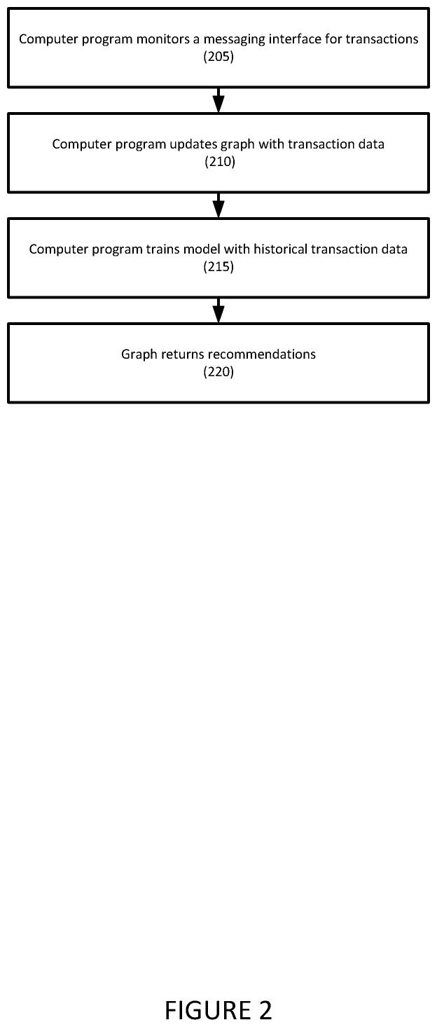

Referring to FIG. 2, a method for predicting recommendations using graph relationships is disclosed according to an embodiment.

In step 205, a computer program, such as a recommendation computer program, may monitor a messaging interface, such as a chat between a customer and a sales representative, for transactions (e.g., trade transactions in which assets have been traded). The transactions may identify, for example, a type of transaction, a client identifier, an asset, a parent company for the asset, a sector for the asset, a country for the asset, a rating for the asset, a maturity for the asset, a currency, etc. Embodiments may create a sub-graph for each transaction.

For example, when a client and a sales representative message in a chat room about an asset, the chat message may be processed with a named entity recognition (NER) model to extract certain information (e.g., asset name, price, etc.). Using this chat data, relationships among clients, sales, and chat messages may be created and/or updated.

In step 210, the computer program may update a graph with data from the transactions data from, for example, transaction trading systems. In one embodiment, the graph may identify assets and clients. For example, when the client trades an asset, the graph may be updated with the trading price, amount, currency etc., and the relationships between client, trade and asset may be updated.

For example, nodes in the graph that are connected with assets (e.g., maturity, rating, country, sector and currency) may be mapped to asset nodes as asset features, so the edges between the asset and these nodes (e.g., maturity, rating, country, sector and currency) may be removed.

For the clients, the neighbor node (e.g., the parent company) may be mapped to the client node for the client as a client node feature. Thus, the edge between the client node and the neighbor node may be removed.

The node trade may be projected into a link between the new asset and client node. Thus, in embodiments, there are only two nodes in the graph asset and client.

In step 215, the computer program may train a graph model, such as a graph neural network (GNN) model, with the completed transaction data. For example, the graph model may be trained with a convolutional layer, such as an inductive node embedding framework, that leverages node feature information to generate node embeddings for previously unseen data using the heterogeneous graph between client node and the asset. An example of such a framework is GraphSAGE. The client node feature and asset node features may be processed with BERT to create sentence embedding. The graph model learns the graph based on node features and relationship topology between the client node and the asset to make the prediction.

The graph model may include additional layers, such as linear layers and classification layers. During training, a sub-batch of graph data may be used. For example, neighbors within two hops may be selected to create the sub-batch, which helps the model to focus on the local graph presentation.

For example, periodically (e.g., daily, hourly, weekly, or as necessary and/or desired), the graph may be queried for information regarding an asset, such as currency, country, maturity, etc. and/or a client identifier, such as relationships for that client node. The graph information may then be used to train the graph model, and the graph model may learn information from the input features to make future predictions.

In step 220, the graph model may return one or more recommendations. For example, the graph model may return predicted probabilities between different assets and the client nodes on how likely they will be connected if they are not connected in the original graph by considering their features and their neighborhood relationships. The recommendations may be ranked based on probabilities for the client node-asset pairs into a recommendation list, and may output the list.

In one embodiment, the results may be grouped based on assets so that there will be a list of clients or client identifiers corresponding to each asset. The client list may be ranked by probability of how likely the client is to trade the asset. The ranked list may identify clients to recommend the asset to, and a sales team may use this list to distribute emails to the clients.

In one embodiment, the recommendation may depend on the client trading history, including the traded asset.

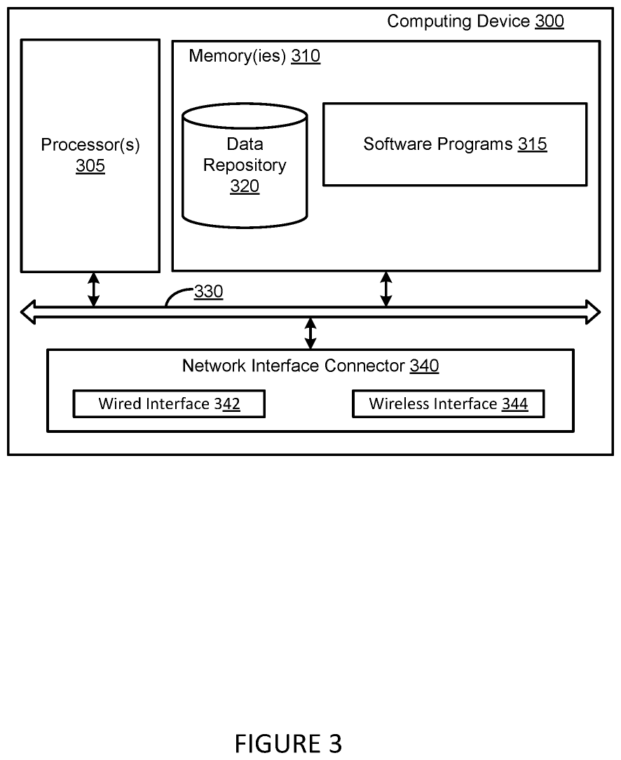

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
monitoring, by a computer program, a messaging interface for transactions;
updating, by the computer program, a heterogeneous graph with data from the transactions, wherein the heterogeneous graph identifies a plurality of assets and a plurality of clients;
training, by the computer program, a graph model with the heterogeneous graph;
querying, by the computer program, the graph model with one of the plurality of assets, wherein the graph model returns a recommendation that identifies a subset of the plurality of clients for the asset; and
outputting, by the computer program, the recommendation.

2. The method of claim 1, wherein the messaging interface comprises a chat interface, and further comprising:
extracting, by the computer program, the data from chat in the chat interface using a named entity recognition model.

3. The method of claim 1, wherein each transaction identifies a type of transaction, a client identifier, an asset, and a currency for the asset.

4. The method of claim 3, wherein each transaction further identifies a parent company for the asset, a sector for the asset, a country for the asset, a rating for the asset, and/or a maturity for the asset.

5. The method of claim 1, wherein the step of updating a graph with data from the transactions comprises:
mapping, by the computer program, asset features to asset nodes in the heterogeneous graph;
removing, by the computer program, nodes for the asset features from the graph;
mapping, by the computer program, neighbor nodes that are connected to client nodes to the client node; and
removing, by the computer program, edges between the neighbor nodes and the client node.

6. The method of claim 1, further comprising:
ranking, by the computer program, the subset of the plurality of clients based on a probability of how likely each of the clients is to trade the asset.

7. The method of claim 6, wherein the probability is further based on a trading history of each client.

8. A system, comprising:
a messaging interface; and
an electronic device comprising a computer processor and executing a computer program, wherein the computer program is configured to monitor the messaging interface for transactions, to update a heterogeneous graph with data from the transactions, wherein the heterogeneous graph identifies a plurality of assets and a plurality of clients, to train a graph model with the heterogeneous graph, to query the graph model with one of the plurality of assets, wherein the graph model returns a recommendation that identifies a subset of the plurality of clients for the asset, and to output the recommendation.

9. The system of claim 8, wherein the messaging interface comprises a chat interface, and the computer program is further configured to extract the data from chat in the chat interface using a named entity recognition model.

10. The system of claim 8, wherein each transaction identifies a type of transaction, a client identifier, an asset, and a currency for the asset.

11. The system of claim 10, wherein each transaction further identifies a parent company for the asset, a sector for the asset, a country for the asset, a rating for the asset, and/or a maturity for the asset.

12. The system of claim 8, wherein the computer program is configured to update the graph with data from the transactions by mapping asset features to asset nodes in the heterogeneous graph, by removing nodes for the asset features from the graph, by mapping neighbor nodes that are connected to client nodes to the client node, and by removing edges between the neighbor nodes and the client node.

13. The system of claim 8, computer program is further configured to rank the subset of the plurality of clients based on a probability of how likely each of the clients is to trade the asset.

14. The system of claim 13, wherein the probability is further based on a trading history of each client.

15. A non-transitory computer readable storage medium, including instructions stored thereon, which when read and executed by one or more computer processors, cause the one or more computer processors to perform steps comprising:
monitoring a messaging interface for transactions;
updating a heterogeneous graph with data from the transactions, wherein the heterogeneous graph identifies a plurality of assets and a plurality of clients;
training a graph model with the heterogeneous graph;
querying the graph model with one of the plurality of assets, wherein the graph model returns a recommendation that identifies a subset of the plurality of clients for the asset; and
outputting the recommendation.

16. The non-transitory computer readable storage medium of claim 15, further including instructions stored thereon, which when read and executed by one or more computer processors, cause the one or more computer processors to perform steps comprising:
extracting the data from chat in the messaging interface using a named entity recognition model.

17. The non-transitory computer readable storage medium of claim 15, wherein each transaction identifies a type of transaction, a client identifier, an asset, and a currency for the asset.

18. The non-transitory computer readable storage medium of claim 17, wherein each transaction further identifies a parent company for the asset, a sector for the asset, a country for the asset, a rating for the asset, and/or a maturity for the asset.

19. The non-transitory computer readable storage medium of claim 15, wherein the graph is updated with data from the transactions by:
mapping asset features to asset nodes in the heterogeneous graph;
removing nodes for the asset features from the graph;
mapping neighbor nodes that are connected to client nodes to the client node; and
removing edges between the neighbor nodes and the client node.

20. The non-transitory computer readable storage medium of claim 15, further including instructions stored thereon, which when read and executed by one or more computer processors, cause the one or more computer processors to perform steps comprising:
ranking the subset of the plurality of clients based on a probability of how likely each of the clients is to trade the asset, wherein the probability is further based on a trading history of each client.
